(19) United States
(12) Patent Application Publication
(10) Pub. No.: US 2008/0295794 A1
(43) Pub. Date: Dec. 4, 2008

(54) WORKING APPARATUS

(75) Inventor: Jurgen STEINHAUSER, Stuttgart (DE)

Correspondence Address: FOLEY AND LARDNER LLP;SUITE 500, 3000 K STREET NW, WASHINGTON, DC, 20007, US

(73) Assignee: ANDREAS STIHL AG & CO. KG

(21) Appl. No.: 12/124,259

(22) Filed: May 21, 2008

(30) Foreign Application Priority Data
May 31, 2007 (DE) 10 2007 025 376.3

(51) Int. Cl. F02N 3/02

(52) U.S. Cl. 123/185.2

(57) ABSTRACT

A working apparatus has a start device arranged in a housing of the working apparatus. The start device comprises a starter grip for actuating the start device, which starter grip is connected to a starter rope. A safety device is provided for the starter grip.

### CROSS-REFERENCE TO RELATED PATENT APPLICATIONS

The right of foreign priority is claimed under 35 U.S.C. § 119(a) based on Federal Republic of Germany Application No. 10 2004 007 510.7, filed Feb. 13, 2004, the entire contents of which, including the specification, drawings, claims and abstract, are incorporated herein by reference.

### BACKGROUND OF THE INVENTION

The invention relates to a working apparatus, in particular a portable hand-held working apparatus, such as a motor saw, a cut-off grinder or the like, of the type specified in the preamble of Claim 1.

A hand-held working apparatus, namely a motor saw having a start device with a starter grip, is known from DE 297 20 866 U1. The starter grip is connected to a starter rope wound on a pull-rope drum.

The starter grip projects from the housing unsecured. As a result, the working apparatus can readily be started by anyone familiar with the operating and the starting of the working apparatus. Accidental starting of the working apparatus is not ruled out either.

### SUMMARY OF THE INVENTION

The invention is based on the object of providing a working apparatus of the generic type, in which unauthorized and/or accidental starting of the drive motor of the working apparatus is prevented.

This object is achieved by a working apparatus having the features of Claim 1.

The safety device prevents the starter grip from being actuated accidentally or without authorization. The working apparatus cannot be started without actuating the starter grip. Unauthorized or accidental starting of the working apparatus is thus prevented in a simple manner.

Advantageously, the safety device protects the starter grip in relation to the housing from accidental actuating of the starter grip. Advantageously, the housing has a socket for the starter grip. The socket in the housing is in this case advantageously arranged and configured in such a way that the starter grip is drawn, on retraction of the starter rope, from the starter rope into the socket in the housing. This ensures that the starter grip is again arranged in the socket after starting of the working apparatus. In particular, the starter grip has a grip portion and the socket in the housing is configured for at least partly receiving the grip portion of the starter grip. Advantageously, the grip portion of the starter grip is arranged substantially or completely in the socket in the housing. As a result, the starter grip does not protrude, or protrudes only slightly, beyond the housing of the working apparatus. Accidental actuating of the starter grip is thus prevented. For starting the working apparatus, the operator must consciously remove the starter grip from the socket. Provision may be made for the starter grip to have a shaft and for the socket in the housing to receive at least a portion of the shaft. Advantageously, the grip portion and shaft of the starter grip are arranged substantially, in particular completely, in the socket.

Advantageously, the safety device comprises safety means which prevent extraction of the starter grip for starting the drive motor. Advantageously, the safety means hold the starter grip in the socket. This prevents the starter grip from becoming accidentally detached from the socket. Extraction of the starter grip can however also be prevented at other components connected to the starter grip. For example, the safety means can block a rope drum connected to the starter grip. The safety means advantageously comprise at least one locking means. This allows the starter grip to be held in a simple manner in the socket. The locking means is in particular resiliently mounted in the direction of the engaged position of the starter grip. Provision may be made for an actuating means to be provided for releasing the locking means. Advantageously, the safety means holds the starter grip transversely to the actuating direction of the starter grip, i.e. perpendicularly to the actuating direction or at an angle thereto. Provision may however also be made for the safety means to hold the starter grip parallel to the actuating direction of the starter grip.

Advantageously, the safety means comprise means for fixing the starter grip to the housing in a form-fitting manner. In the case of form-fitting fixing, the starter grip is held securely on the housing. Advantageously, the starter grip has at least one interlocking means which interacts, for fixing the starter grip in a form-fitting manner, with interlocking means in the socket in the housing. Form-fitting fixing of the starter grip to the housing can thus be achieved in a simple manner. In particular, one interlocking means is configured as a depression and the other interlocking means is configured as an elevation interacting with the depression, the depression having an inlet and extending at least partly in the circumferential direction. The force, conventionally acting on the starter rope, of the restoring spring of the pull-rope starter acts in the longitudinal direction of the starter rope, i.e. conventionally also in the longitudinal direction of the socket. A depression extending in the circumferential direction of the socket allows the starter grip to be secured in a simple manner in relation to the force of the restoring spring and in relation to the actuating force of an operator. The depression can in this case in particular be configured in such a way that the force of the restoring spring holds the interlocking means in the depression.

Simple securing of the starter grip in the socket is obtained if the starter grip is connected to a rope drum and the safety means block the rope drum. It can be advantageous, for securing the starter grip, to provide blocking of other components which are operatively connected to the starter grip. In particular, blocking can also be provided on the starter rope.

In order to prevent accidental or unauthorized starting of the working apparatus, provision may also be made for the starter grip to be releasably connected to the starter rope via a fixing device. This allows the starter grip to be detached when the working apparatus is not in operation. This also deters thieves, as the working apparatus is unusable if it cannot be started. Advantageously, an actuating device is provided for the fixing device. In particular, the fixing device connects the starter grip to the starter rope when the actuating device is actuated. As soon as the operator releases the actuating device, the starter grip becomes detached from the starter rope. This ensures that the starter grip is separated from the starter rope at all times apart from during the starting process.

A simple configuration is obtained if the fixing device has a coupling element and a socket for the coupling element. The coupling element is in this case advantageously arranged on the starter rope and the socket for the coupling element is arranged on the starter grip. Advantageously, a portion of the socket for the coupling element is configured so as to be movable and can be moved by the actuating device. A releasable connection between the starter grip and starter rope can thus easily be achieved. Advantageously, the coupling element is held in the socket for the coupling element via at least one spring element, and the actuating device acts on the spring element. Fixing the starter grip to the starter rope requires, in particular, no actuation, as the fixing can be carried out counter to the force of the spring element. For releasing, the spring element must in particular be released via the actuating device.

In order to ensure that a working apparatus can be started only with an associated starter grip and in order thus to achieve effective theft prevention, provision is made for at least a portion of the socket for the coupling element and an associated portion of the coupling element to have a mutually adapted, in particular non-uniform cross section, the socket closely surrounding the portion of the coupling element. The socket and the portion of the coupling element advantageously interact like a lock and key. Only the starter grip which is adapted to the working apparatus can be fixed to the starter rope, as in other starter grips the socket and coupling element do not fit together and fixing is therefore not possible. The starter grip thus acts as a key for the working apparatus.

In order to allow simple fixing of the starter grip to the starter rope, a position securing means is provided for defining the rotary position of the coupling element in relation to the housing of the working apparatus. A simple connection between the socket and the coupling element can be achieved if the socket for the coupling element comprises at least one depression extending in the circumferential direction. Advantageously, the coupling element comprises at least one coupling bolt which is guided in the depression which is advantageously configured as a guide groove. A coupling can thus easily be achieved. Advantageously, the guide groove has an inlet for the coupling bolt, so that the coupling bolt can be arranged in the guide groove in a simple manner. In particular, a connection is possible by inserting and rotating the components in relation to one another. Provision may also be made for the coupling element to comprise at least one depression extending in the circumferential direction and for the socket for the coupling element to comprise at least one coupling bolt which is guided in the depression.

In order to ensure that the starter grip is released from the starter rope after start-up, means are provided for releasing, in particular for automatically releasing, the starter grip from the starter rope on retraction of the starter rope into the housing of the working apparatus. The starter grip is in this case released from the starter rope, in particular, as a function of the relative movement of the starter grip and housing. Advantageously, the starter grip and the housing have interacting guide means which bring about a relative movement of the starter grip in relation to the starter rope on retraction of the starter grip. The relative movement can be used for uncoupling the starter grip and starter rope. Advantageously, the relative movement is a rotational movement. Other types of relative movements, for example a lateral movement of the starter grip or starter rope, can however also be provided. Expediently, the coupling bolt of the coupling element is moved toward the inlet of the guide groove during the rotational movement in the guide groove. The relative movement thus causes a release of the starter rope and starter grip. In order to achieve a secure release, there is provided a spring element which acts in the direction of the relative movement and assists the relative movement. Provision may also be made for the spring element to trigger the relative movement.

Advantageously, the drive motor of the working apparatus is an internal combustion engine.

Further objects, features and advantages of the present invention will become apparent from the detailed description of preferred embodiments that follows, when considered together with the accompanying figures of drawing.

### BRIEF DESCRIPTION OF THE DRAWINGS

Exemplary embodiments of the invention will be described hereinafter with reference to the drawings, in which:

FIG. 1 is a perspective view of a motor saw;

FIG. 2 is a schematic view of the start device of the motor saw from FIG. 1;

FIG. 3 is a sectional view of the starter grip of the motor saw from FIG. 1;

FIG. 4 is a sectional view of an exemplary embodiment of the starter grip;

FIG. 5 is a perspective view of an exemplary embodiment of the motor saw from FIG. 1 with a secured starter grip;

FIG. 6 shows the motor saw from FIG. 5 with a released starter grip;

FIG. 7 shows an exemplary embodiment of the motor saw from FIG. 1 with a secured starter grip;

FIG. 8 shows the motor saw from FIG. 7 with a released starter grip;

FIG. 9 is a perspective view of an exemplary embodiment of a starter grip;

FIG. 10 is a sectional view of an exemplary embodiment of a starter grip in the position released from the starter rope;

FIG. 11 shows the starter grip from FIG. 10 in the position fixed to the starter rope;

FIG. 12 is a sectional view of an exemplary embodiment of a starter grip in the position fixed to the starter rope;

FIG. 13 shows the starter grip from FIG. 12 in the position released from the starter rope;

FIG. 14 is a sectional view of an exemplary embodiment of a starter grip in the position fixed to the starter rope;

FIG. 15 shows the starter grip from FIG. 14 on release of the starter grip;

FIG. 16 shows the starter grip from FIG. 14 in the released position;

FIG. 17 is a section through the starter grip from FIG. 14 at the level of the line XVII-XVII in FIG. 14;

FIG. 18 shows an exemplary embodiment of a starter grip during pulling of the starter grip;

FIG. 19 shows the starter grip from FIG. 18 during fixing to the housing;

FIG. 20 shows the starter grip from FIG. 18 in the fixed position;

FIG. 21 shows an exemplary embodiment of a starter grip in the extended position;

FIG. 22 shows an exemplary embodiment of a starter grip in the position uncoupled from the starter rope;

FIG. 23 is a perspective, cut-away view of an exemplary embodiment of a starter grip in the position released from the starter rope;

FIG. 24 is a sectional view of a detail of the starter grip from FIG. 23;

FIG. 25 is a sectional view of the starter grip from FIG. 23 during fixing of the starter grip to the starter rope;

FIG. 26 is a sectional view of a variation of the exemplary embodiment from FIG. 4; and

FIG. 27 is a schematic view of an exemplary embodiment of a start device.

### DETAILED DESCRIPTION OF THE PREFERRED EMBODIMENTS

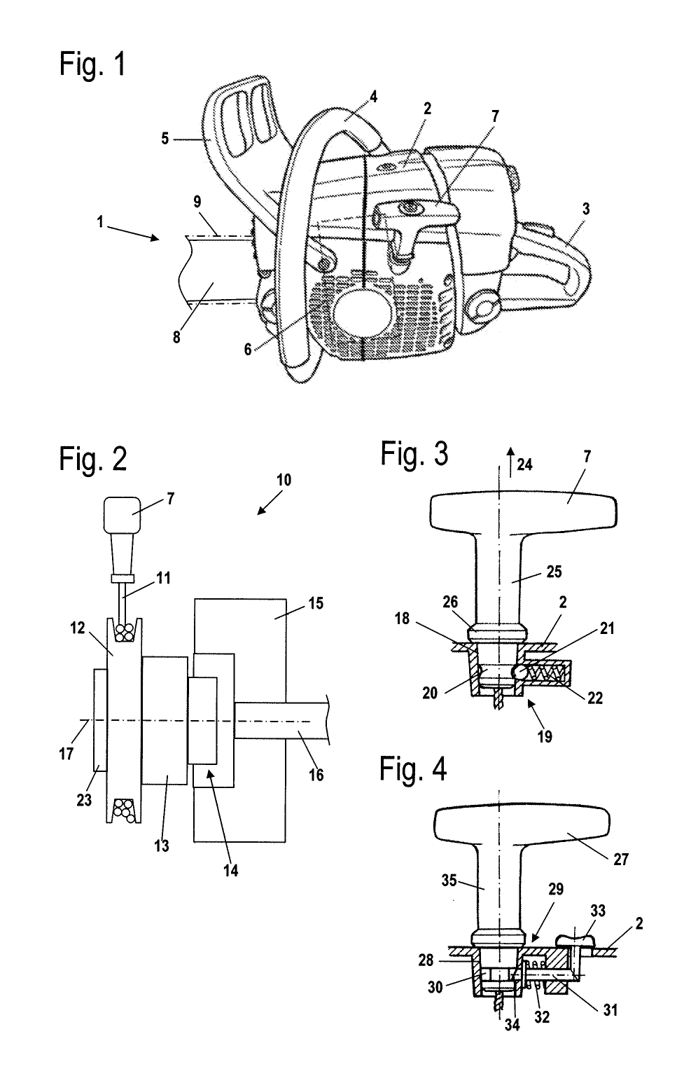

The hand-held, motor-driven working apparatus shown in FIG. 1 is configured as a motor saw 1. The motor saw 1 has a housing 2 to which a rear handle 3 and a grip tube 4 are secured for guiding the motor saw 1. A guide rail 8, about which a saw chain 9 is driven in circulation, is secured to the housing 2. The saw chain 9 is driven by a drive motor 6 arranged in the housing 2.

Adjacent to the grip tube 4, a hand guard 5 is arranged on the housing 2 on the side of the grip tube 4 that faces the saw chain 9. The drive motor 6 is configured as an internal combustion engine, in particular as a single-cylinder two-stroke motor or as a single-cylinder four-stroke motor, preferably as an oil-in-gasoline-lubricated four-stroke motor. A start device, which comprises a starter grip 7 projecting from the housing 2, is provided for starting the drive motor 6.

The construction of the start device 10 is shown schematically in FIG. 2. The starter grip 7 is connected to a starter rope 11 which is wound on a rope drum 12. The rope drum 12 is mounted so as to be able to rotate about an axis of rotation 17. A restoring spring 23, which is held in the housing 2 (not shown in FIG. 2) of the motor saw 1, acts on the rope drum 12. The rope drum 12 is connected to a coupling device 14 via a damping device 30. The coupling device 14 can, for example, comprise a catch and serve to connect the damping device 13 to a fan wheel 15 which is non-rotatably arranged on a crankshaft 16 of the drive motor 6. The coupling device 14 can also be connected directly to the crankshaft 15 of the drive motor 6. Instead of the damping device 13, the start device 10 can also comprise a starter spring which is raised via a plurality of strokes of the starter rope 11 and which then starts the drive motor 6.

FIG. 3 shows the safety device with which the starter grip 7 is protected in relation to the housing 2 from accidental actuating. The safety device is configured as a locking device 19. The starter grip 7 has a shaft 25, the lower portion of which projects into a socket 18 formed on the housing 2. A peripheral edge 26, which forms a stop for the housing 2 and delimits the depth to which the starter grip 7 is inserted into the housing 2, is provided on the shaft 25. At the portion projecting into the socket 18, the shaft 25 has a peripheral groove 20. A locking means, namely a ball 21 at the level of the groove 20 that is pressed by a compression spring 32 into the groove 20, is mounted on the housing 2. As a result, the starter grip 7 is protected from the ball 21 transversely to the actuating direction 24 of the starter grip.

FIG. 4 shows a starter grip 27 having a shaft 35. A lower portion of the shaft 35 is arranged in a socket 28 in a housing of a working apparatus, for example the housing 2 of the motor saw 1. A locking device 29, which comprises a slide 31, is provided for securing the starter grip 27. The slide 31 has a locking lug 34 which protrudes into a peripheral groove 30 on the shaft 35 and as a result fixes the starter grip 27 in the socket 28. The slide 31 is loaded by a compression spring 32 in the direction of the locking position of the slide. For actuating the slide 31, the slide 31 has an actuating element 33 which projects onto the outside of the housing 2 and can be actuated by the operator for releasing the locking device 29.

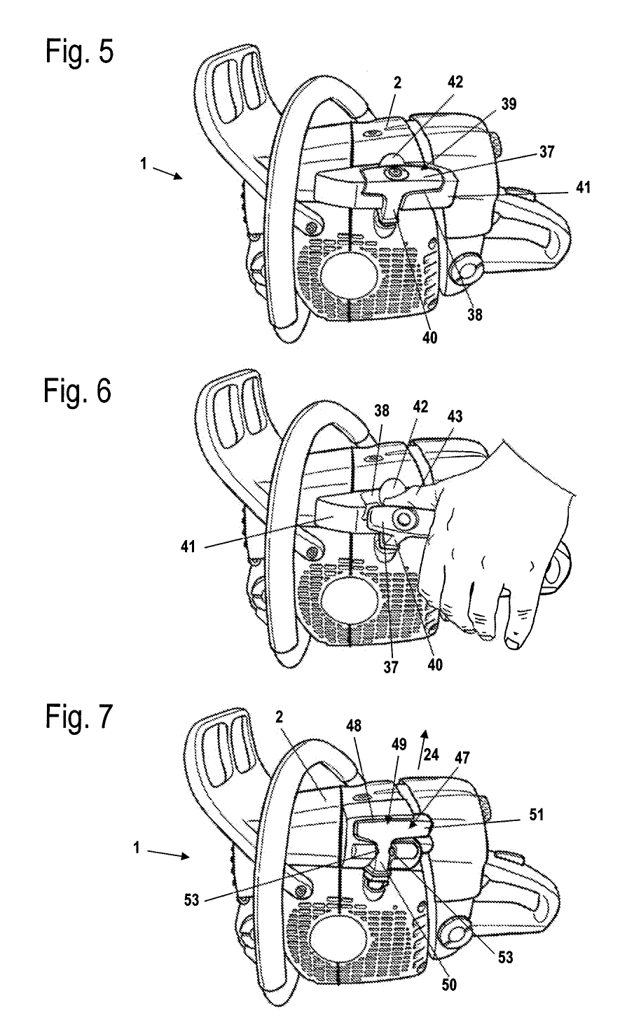

FIGS. 5 and 6 show a further exemplary embodiment of a locking device with which a starter grip 37 is secured to a housing 2 of a motor saw 1. An attachment part 41, which forms a socket 38 for the starter grip 37, is provided on the housing 2. The starter grip 37 has a grip portion 39, which the operator can use to grip the starter grip 37, and also a shaft 40. Both the shaft 40 and the grip portion 39 are arranged entirely in the socket 38. The socket 38 is arranged and configured in such a way that the starter grip 37 is drawn, on release of the starter rope, by the restoring spring 23 of the start device 10 into the socket 38. This ensures that the starter grip 37 is automatically arranged in the socket 38. Adjacent to the grip portion 39, a recessed grip 42 for the operator's thumb 43 is provided on the socket 38. This is shown in FIG. 6. In order to press the starter grip 37 out of the socket 38, the user can push his thumb 43 into the recessed grip 42 and remove the starter grip 37 from the socket 38. As a result of the fact that the starter grip 37 is arranged entirely in the socket 38 and does not protrude beyond the contour of the motor saw 1, accidental actuating of the starter grip 37 is prevented.

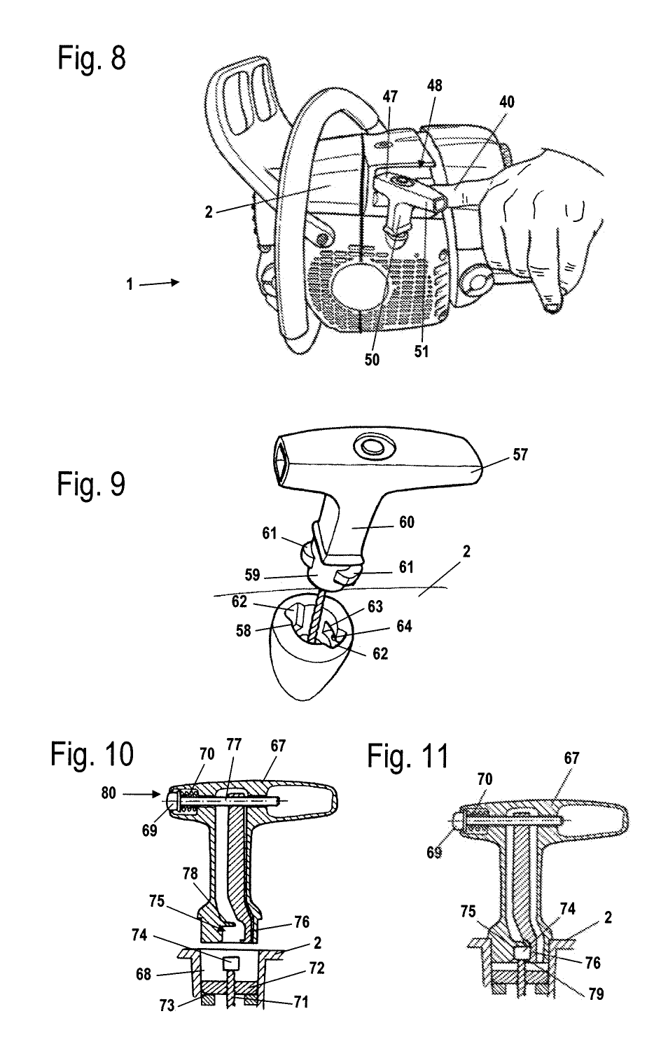

FIGS. 7 and 8 show a further exemplary embodiment of a starter grip 47. The starter grip 47 has a grip portion 49 and also a shaft 50. A socket 48, in which the grip portion 49 and the shaft 50 are substantially arranged, is formed in the housing 2. Merely a protruding end 51 of the grip portion 49 projects from the socket 48. The socket 48 is integrated into the housing 2. The socket 48, like the socket 38, is configured in such a way that the starter grip 47 is automatically drawn into the socket 48 on retraction of the starter part. The locking means 53 shown in FIG. 7, which act transversely to the actuating direction 24 of the starter grip 47 and fix the actuating grip 47 in the socket 48, are provided for securing the starter grip 47 in the socket 48. The locking means 53 can, for example, be spring-loaded balls. The locking means 53 can however also be manufactured as plastics material parts in one piece with the housing 2 of the motor saw 1.

For starting the motor saw 1, the starter grip 47 is, as shown in FIG. 8, pressed out of the socket 48 at the protruding end 51. For this purpose, the operator can press his thumb 40 on the protruding end 51. Once released from the socket 48, the working apparatus can be started by pulling on the starter grip 47 in the actuating direction 24 (FIG. 7).

FIG. 9 shows a starter grip 57 which is secured in relation to the housing 2 with a form-fitting connection. The starter grip 57 has a shaft 60, the lower end of which forms a connecting piece 59. Radially outwardly projecting interlocking lugs 61 are provided on the connecting piece 59. The exemplary embodiment shows two interlocking lugs 61 diametrically opposing one another. A different number of interlocking lugs 61 can however also be provided. A socket 58 for the connecting piece 59 is formed on the housing 2. The socket 58 has for each interlocking lug 61 a depression which is formed as a circumferential groove 63. Each circumferential groove 63 is connected to an inlet 62 on the end face of the socket 58. The interlocking lugs 61 of the starter grip 57 can be inserted into the circumferential groove 63 via the inlets 62. For this purpose, the starter grip 57 is inserted into the socket 58 and rotated about its longitudinal axis until the interlocking lugs 61 are arranged after locking lugs 64 arranged in the circumferential groove 63. This secures the starter grip 57 in a form-fitting manner.

In order to prevent accidental and unauthorized actuating of a starter grip, provision is made in the exemplary embodiment according to FIGS. 10 and 11 for the starter grip 67 to be releasable from the starter rope 71. A fixing device, which can be actuated by the operator using an actuating device, is provided for this purpose. As shown in FIG. 10, a coupling element 74 for connecting to the starter grip 67 is provided on the starter rope 71. In order to ensure that the coupling element 74 is not drawn into the housing 2 by the restoring spring 23 but rather remains in a defined position in a socket 68 for the starter grip 67, a holding plate 72, which rests on a stop 73 on the housing 2, is secured to the starter rope 71. A socket 75 for the coupling element 74, which socket is formed between a stationary portion comprising a fixed stop 78 and a movable interlocking means 76, is formed on the starter grip 67. The interlocking means 76 is secured to a bolt 77 which is mounted so as to be able to move in the starter grip 67 and spring-loaded by a compression spring 70. An actuating button 69, which projects out of the starter grip 67, is provided on the bolt 77. The compression spring 70 prestresses the interlocking means 76 into the closed position of the socket 75. In order to connect the starter grip 67 to the starter rope 71, the actuating button 69 is pressed in the direction of the arrow 80 into the position shown in FIG. 10. In this position, the socket 75 can be pushed via the coupling element 74. Subsequently, the actuating button 69 is released and the compression spring 70 presses the interlocking means 76 into the closed position of the socket 75 shown in FIG. 11. As FIG. 11 shows, a holding hook 79, which secures the coupling element 74 in the socket 75, is arranged on the interlocking means 76.

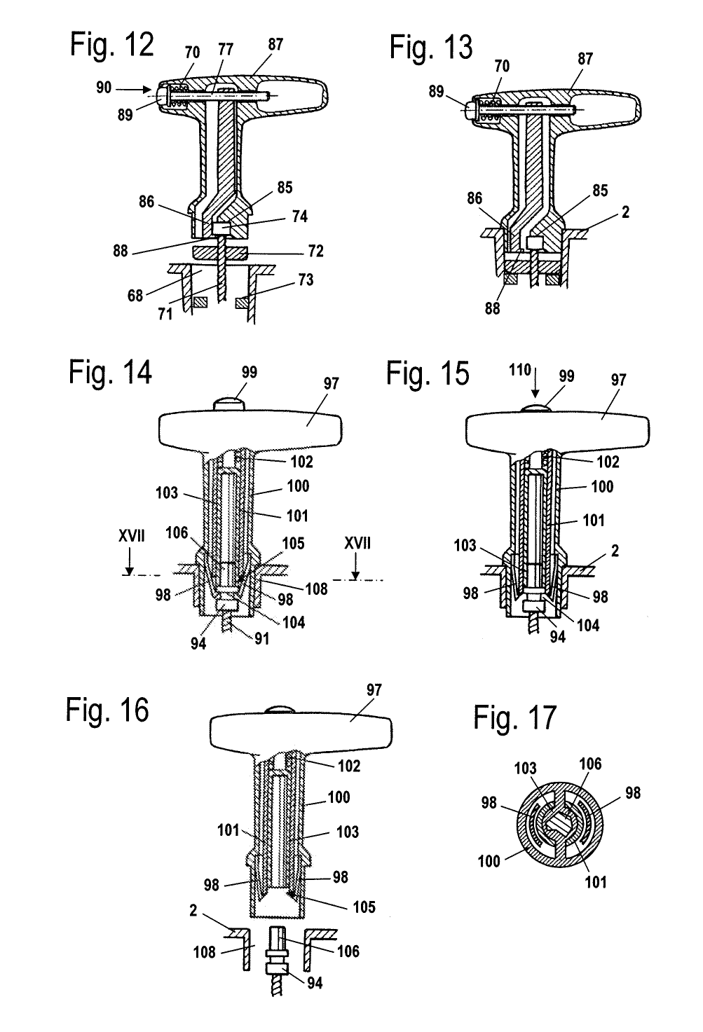

FIGS. 12 and 13 show an exemplary embodiment of a starter grip 87 which likewise has a fixing device for connecting to the starter rope 71. Nevertheless, the device shown in FIGS. 12 and 13 for actuating the fixing device is configured in such a way that the socket 85 for the coupling element 74 is closed when an actuating button 89 is actuated in the direction of an arrow 90. For this purpose, an interlocking means 86 is arranged on the side of the socket 74 that faces the actuating button 89, whereas the interlocking means 76 from FIGS. 10 and 11 is arranged on the side of the socket 75 that is remote from the actuating button 69. The remainder of the construction of the starter grip 87 corresponds substantially to the construction of the starter grip 67 from FIGS. 10 and 11. Like reference numerals denote like components. A holding hook 88 is arranged on the interlocking means 86 to hold the coupling element 74 in the socket 85.

FIG. 13 shows the starter grip 87 with the actuating button 89 released. Owing to the force of the compression spring 70, the interlocking means 86 has been displaced and the socket 85 opened, so that the coupling element 74 can leave the socket 85 and the starter grip 87 is not rigidly connected to the starter rope 71.

FIG. 14 to 17 show a further exemplary embodiment of a starter grip 97 which can be connected to and released from a starter rope 91. The lower portion of the starter grip 97 is arranged in a socket 108 in the housing 2. The starter grip 97 has a socket 105 for the coupling element 94. The socket 105 is formed inside a sleeve-like counter-holder 103 and also on the end face of the counter-holder 103 and is delimited by spring elements 98. The spring elements 98 are inwardly spring-loaded and project, in the closed state of the socket 105 shown in FIG. 14, into a groove 104 in the coupling element 94 and thus hold the coupling element 94 on the end face of the counter-holder 103 in the socket 105. The counter-holder 103 is formed in one piece with a shaft 100 of the starter grip 97 or rigidly connected thereto. As a result, the relative position of the spring elements 98 in relation to the counter-holder 103 is the same at all times. For releasing the starter grip 97, an actuating button 99 of the starter grip 97 is pressed in the direction of the arrow 110 shown in FIG. 15. The actuating button 99 is connected to an actuating sleeve 101 which is arranged radially outside the counter-holder 103 and which actuates and radially outwardly deflects the spring elements 98. As a result, the spring elements 98 are pressed out of the groove 104 in the coupling element 94. The starter grip 97 can accordingly be removed from the coupling element 94, as shown in FIG. 16. A compression spring 102, which rests on the counter-holder 103 and which presses the actuating button 99 into its unactuated position, is provided to adjust the actuating button 99 into its starting position.

The coupling element 94 has a journal 106 which projects inside the counter-holder 103. FIG. 17 shows schematically the cross section of the journal 106 and the counter-holder 103. The outer contour of the journal 106 is adapted to the inner contour of the counter-holder 103. The counter-holder 103 closely surrounds the journal 106. The contours are non-uniform in their configuration. In the exemplary embodiment, the journal 106 has a non-uniform polygonal cross section. However, arcuate or curved partial portions or other non-uniform configurations can also be provided. The fact that the journal 106 projects into the counter-holder 103 means that the cross sections must be adapted to one another. This ensures that only a starter grip 97 which is adapted to the journal 106 can be secured to the starter rope 91. The journal 106 and the counter-holder 103 interact on the basis of the lock-and-key principle. The removal of the starter grip 97 therefore means that the motor saw 1 can be started only when the appropriate starter grip 97 is attached.

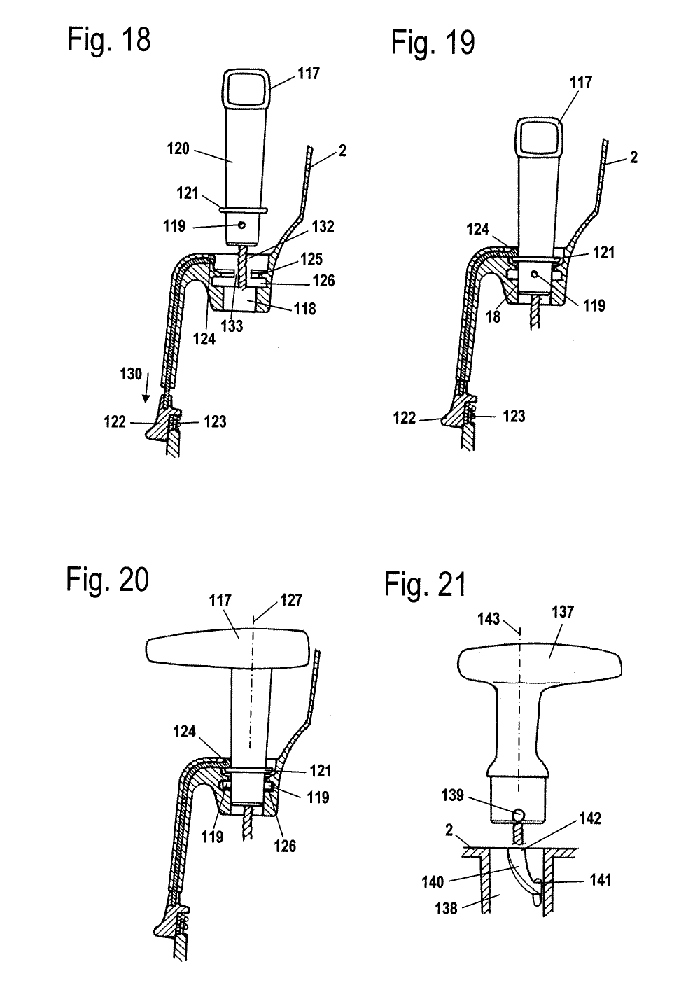

In the exemplary embodiment according to FIG. 18 to 20, two mutually independent safety devices are provided for fixing the starter grip 117 in relation to the housing 2. A first safety device is configured as a locking device and comprises a slide 122 via which an interlocking element 124 can be actuated. The slide 122 is loaded by a compression spring 123 into the closed, i.e. the secured position. The starter grip 117 has a shaft 120 having an interlocking edge 121. The lower portion of the starter grip 117 having the interlocking edge 121 can be arranged in a socket 118. For inserting the starter grip 117, the slide 122 can be actuated in the direction of the arrow 130. Provision may however also be made for the interlocking edge 121 and the interlocking element 124 to be configured in such a way that the starter grip 117 can be pressed into the socket 118, for example by means of corresponding bevels.

The shaft 120 also has, on its lower portion which is to be arranged in the socket 118, two interlocking bolts 119 which in the exemplary embodiment project radially outward. The interlocking bolts 119 can be inserted up to a circumferential groove 126 via an inlet 132 provided on the socket 118. The circumferential groove 126 is configured as a depression in the socket 118. Toward the outside of the housing, the circumferential groove 126 is delimited by an edge 125. The edge 125 has a respective depression 133 for each interlocking bolt 119.

FIG. 19 shows the starter grip 117 in the socket 118. The starter grip 117 is secured by the interlocking element 124. The interlocking bolts 119 can still be withdrawn by means of the depressions 133. For fixing the starter grip 117, the starter grip 117 is rotated about its longitudinal axis 127 shown in FIG. 20. As a result, the interlocking bolts 119 enter the circumferential groove 126 and are secured therein in a form-fitting manner.

A safety device for fixing the starter grip 137 in relation to the housing 2, which safety device comprises interlocking bolts 139 arranged on the starter grip 137, is provided in the exemplary embodiment shown in FIG. 21 of a starter grip 137. The housing 2 has a socket 138 in which a depression configured as a guide groove 140 is provided. The guide groove 140 extends helically, i.e. also in the circumferential direction of the socket 138, and has an inlet 142 which opens out on the end face of the socket 138. A holding depression 141, which extends both into the interior and to the outside of the housing, is provided at the inner end of the guide groove 140. For fixing the starter grip 137 in the socket 138, the starter grip 137 is pushed into the socket 138, so that the interlocking bolts 139 are guided in the guide groove 140. In this case, the starter grip 137 is rotated about its longitudinal axis 143. In the holding depression 141, the starter grip 137 is drawn by the restoring spring 23 into the interior of the housing 2. For actuating the starter grip, the starter grip 137 must be rotated. Otherwise, the interlocking bolts 139 are held in the portion of the holding depression 141 that projects toward the outside 2 of the housing.

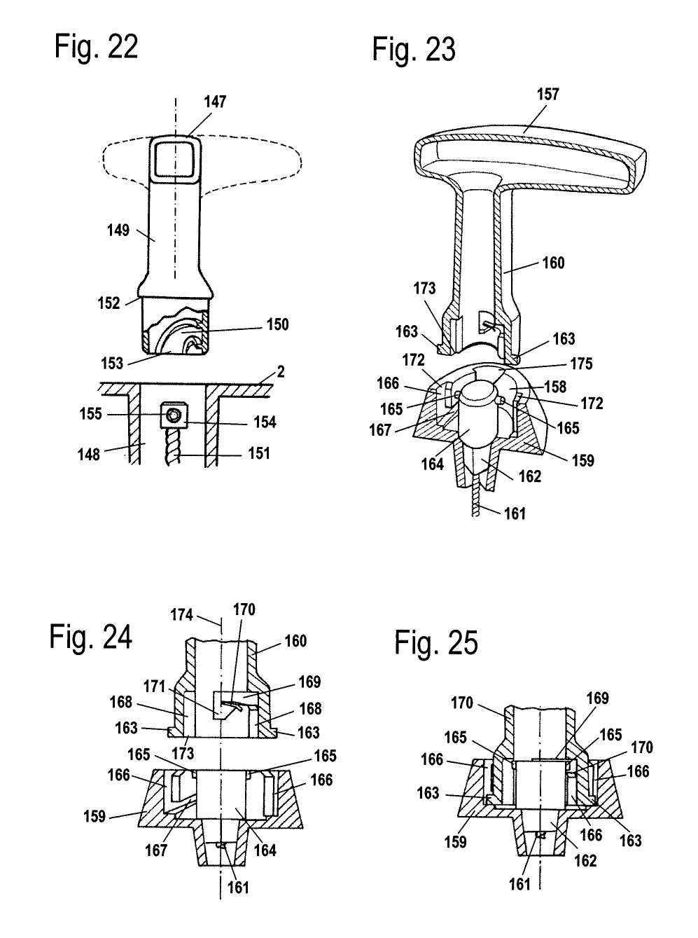

In the exemplary embodiment shown in FIG. 22 of a starter grip 147, the starter grip 147 has, at the end and inside the hollow shaft 149, a guide groove 150 which extends in an arcuate manner in the longitudinal direction and in the circumferential direction and which merges with an inlet 153 on the end face of the shaft 149. The housing 2 has a socket 148 into which the shaft 149 of the starter grip 147 can be inserted up to a shoulder 152. A coupling element 154, which has outwardly projecting coupling bolts 155, is secured to the starter rope 151. Advantageously, two mutually opposing coupling bolts 155 are provided. The starter rope 151 is fixed in the position shown in FIG. 22 via means (not shown), thus preventing the starter rope 151 from being drawn any further into the housing 2. For fixing the starter grip 147, the starter grip 147 is attached to the coupling element 154 and rotated, so that the coupling bolts 155 slide along the guide grooves 150. The guide grooves 150 are closed at their end and extend at their end back toward the housing 2, so the actuating force or the force of the restoring spring 23 holds the starter grip 147 on the starter rope 151.

A further exemplary embodiment of a starter grip 157 is shown in FIG. 23 to 25. The starter grip 157 has a shaft 160, at the lower end of which two outwardly projecting guide lugs 163 are configured. The shaft 160 is hollow in its configuration and has in its interior two first guide grooves 168 which are configured parallel to the longitudinal axis 174 and second guide grooves 169 which extend in the circumferential direction and adjoin the first guide grooves 168. The second guide grooves 169 end in a widened end region 171 extending slightly toward the end face of the shaft 160. A spring element 170 is arranged in the region of the end region 171.

As shown in FIG. 23, a coupling element 164, which has two radially outwardly projecting coupling bolts 165 which are arranged opposing one another and can be arranged in the guide grooves 168 and 169, is provided on the starter rope 161. A base 159, which is rigidly connected to the housing 2, is provided. The housing 2 is not shown in FIG. 23 to 25.

The base 159 can also be configured in one piece with the housing 2. A socket 158 for the lower portion of the shaft 160 of the starter grip 157 is formed in the base 159. The coupling element 164 has a position securing means 162 which secures the rotary position of the coupling element 164 in relation to the base 159.

The socket 158 has first guide grooves 166 extending parallel to the longitudinal axis 174 shown in FIG. 24 and second guide grooves 167 extending on the circumference at an inclination. The first guide grooves 166 merge with inlets 172 on the end face of the socket 158. The second guide grooves 167 merge with outlets 175 on the end face of the socket 158. The second guide grooves 167 extend substantially helically in relation to the end face of the socket 158.

For fixing the starter grip 157 to the starter rope 161, the starter grip 157 is inserted into the socket 158 in such a way that the guide lugs 163 slide along the first guide grooves 166 which are formed as depressions of the socket 158. In this case, the coupling bolts 156 also slide along the first guide grooves 168 of the shaft 160. The first guide grooves 168 merge with inlets 173 on the end face of the shaft 160, via which inlets the coupling bolts 165 enter the first guide grooves 168. This end position is shown in FIG. 25. Subsequently, the starter grip 157 is rotated in such a way that the guide lugs 163 slide down the second guide grooves 167. In this case, the coupling bolts 165 slide down the second guide grooves 169 inside the shaft 160 until they enter the end region 171. In this case, the coupling bolts 165 actuate and tension the two spring elements 170. Pulling the starter grip 157 causes the starter grip 157 to be drawn out of the socket 158 in such a way that the guide lugs 163 leave the second guide grooves 167 through the outlets 175.

On retraction of the starter rope 161, the guide lugs 163 enter the second guide grooves 167 through the outlets 157. The restoring spring 23 causes the coupling element 164, and thus also the starter grip 157, to be drawn further into the socket 158 until the coupling element 164 rests against the base of the socket 158. The oblique position of the second guide groove 167 causes rotation of the starter grip 157. In this case, the coupling bolts 165 slide in the second guide grooves 169 to the first guide grooves 168. This is assisted by the spring elements 170. The position securing means 162 prevents corotation of the coupling element 164, resulting in relative rotation of the starter grip 157 in relation to the coupling element 164, which relative rotation brings the coupling bolts 165 into the region of the first guide grooves 168. In this position, the starter grip 157 can be removed. The starter grip 157 is no longer held on the housing 2.

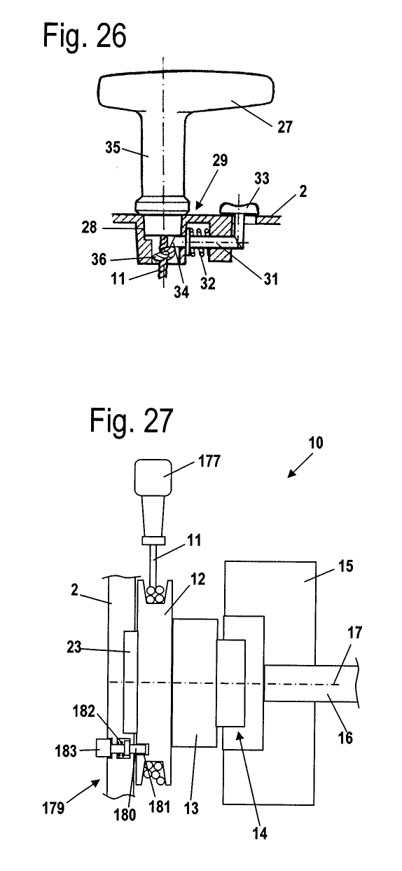

FIG. 26 shows an embodiment variation of the locking device 29 shown in FIG. 4. Like reference numerals denote in this case like components. The locking lug 34 interacts, in the exemplary embodiment according to FIG. 26, with a knot 36 in the starter rope 11 and holds the knot 36 in the region of the socket 28. This prevents withdrawal of the starter grip 27 from the housing 2. The knot 36 can also be arranged at a different point of the starter rope 11. Instead of a knot 36, other means for fixing to the starter rope 11 can also be provided. For example, transverse bolts, nipples or the like can be sprayed onto the starter rope 11.

FIG. 27 shows an exemplary embodiment of the start device 10 shown in FIG. 2. In this case too, like reference numerals denote like components. The start device 10 has a starter grip 177 which is connected to a rope drum 12 via a starter rope 11. The end of the starter rope 11 that faces the rope drum 12 is fixed to the rope drum 12. The start device 10 has a locking device 179 which blocks the rope drum 12 in the position shown in FIG. 27. The locking device 179 is secured to the housing 2 adjacent to the rope drum 12 and comprises a journal 180 which projects, in the locking position shown in FIG. 27, into a depression 181 in the rope drum 12. The journal 180 is loaded by a compression spring 182 in the direction of the blocked position of the rope drum 12. An actuating button 183 is provided for the purposes of actuation, i.e. for releasing the locking device 179. In order to release the rope drum 12, the actuating button 183 must be withdrawn from the housing 2. Withdrawal of the starter grip 177 from the housing 2 and rotation of the rope drum 12 via the starter rope 11 are then possible. In the exemplary embodiment in FIG. 27, the actuating button 183 must be held during the starting process. However, a device which holds the actuating button 183 in the released position of the rope drum 12 during the starting process can also be provided.

Other configurations of safety devices can also be provided.

The foregoing description of preferred embodiments of the invention has been presented for purposes of illustration and description only. It is not intended to be exhaustive or to limit the invention to the precise form disclosed, and modifications and variations are possible and/or would be apparent in light of the above teachings or may be acquired from practice of the invention. The embodiments were chosen and described in order to explain the principles of the invention and its practical application to enable one skilled in the art to utilize the invention in various embodiments and with various modifications as are suited to the particular use contemplated. It is intended that the scope of the invention be defined by the claims appended hereto and that the claims encompass all embodiments of the invention, including the disclosed embodiments and their equivalents.

What is claimed is:

1. A working apparatus having a start device for starting a drive motor, the start device being arranged in a housing of the working apparatus and comprising a starter grip or actuating the start device, which starter grip is connected to a starter rope, wherein a safety device is provided for the starter grip.

2. The working apparatus as claimed in claim 1, wherein the safety device protects the starter grip in relation to the housing from accidental actuating of the starter grip.

3. The working apparatus as claimed in claim 1, wherein the housing has a socket for the starter grip.

4. The working apparatus as claimed in claim 2, wherein the housing has a socket for the starter grip.

5. The working apparatus as claimed in claim 3, wherein the socket in the housing is arranged and configured in such a way that the starter grip is drawn, on retraction of the starter rope, from the starter rope into the socket in the housing, wherein the starter grip has a grip portion and wherein the socket in the housing is configured for at least partly receiving the grip portion of the starter grip.

6. The working apparatus as claimed in claim 3, wherein the starter grip has a shaft and the socket in the housing receives at least a portion of the shaft.

7. The working apparatus as claimed in claim 3, wherein the safety device comprises safety means which prevent extraction of the starter grip for starting the drive motor.

8. The working apparatus as claimed in claim 6, wherein the safety means comprise at least one locking means, wherein the locking means is resiliently mounted in the direction of the engaged position of the starter grip and wherein an actuating means is provided for releasing the locking means.

9. The working apparatus as claimed in claim 6, wherein the safety means holds the starter grip transversely to the actuating direction of the starter grip.

10. The working apparatus as claimed in claim 6, wherein the safety means holds the starter grip parallel to the actuating direction of the starter grip.

11. The working apparatus as claimed in claim 6, wherein the safety means comprise means for fixing the starter grip to the housing in a form-fitting manner.

12. The working apparatus as claimed in claim 10, wherein the starter grip has at least one interlocking means which interacts, for fixing the starter grip in a form-fitting manner, with interlocking means in the socket in the housing and wherein one interlocking means is configured as a depression and the other interlocking means is configured as an elevation interacting with the depression, the depression having an inlet and extending at least partly in the circumferential direction.

13. The working apparatus as claimed in claim 6, wherein the starter grip is connected to a rope drum and wherein the safety means block the rope drum.

14. The working apparatus as claimed in claim 1, wherein the starter grip is releasably connected to the starter rope via a fixing device.

15. The working apparatus as claimed in claim 13, wherein an actuating device is provided for the fixing device and wherein the fixing device connects the starter grip to the starter rope when the actuating device is actuated.

16. The working apparatus as claimed in claim 13, wherein the fixing device has a coupling element and a socket for the coupling element.

17. The working apparatus as claimed in claim 15, wherein the coupling element is arranged on the starter rope and the socket for the coupling element is arranged on the starter grip and wherein a portion of the socket is configured so as to be movable and can be moved by the actuating device.

18. The working apparatus as claimed in claim 16, wherein the coupling element is held in the socket for the coupling element via at least one spring element and the actuating device acts on the spring element.

19. The working apparatus as claimed in claim 15, wherein at least a portion of the socket for the coupling element and an associated portion of the coupling element have a mutually adapted, in particular non-uniform cross section, the socket closely surrounding the portion of the coupling element.

20. The working apparatus as claimed in claim 15, wherein a position securing means is provided for defining the rotary position of the coupling element in relation to the housing of the working apparatus.

21. The working apparatus as claimed in claim 15, wherein the socket for the coupling element comprises at least one depression extending in the circumferential direction, wherein the coupling element comprises at least one coupling bolt which is guided in the depression which is configured as a guide groove and wherein the guide groove has an inlet for the coupling bolt.

22. The working apparatus as claimed in claim 15, wherein means are provided for releasing the starter grip from the starter rope on retraction of the starter rope into the housing of the working apparatus.

23. The working apparatus as claimed in claim 21, wherein the starter grip and the housing have interacting guide means which bring about a relative movement of the starter grip in relation to the starter rope on retraction of the starter grip.

24. The working apparatus as claimed in claim 22, wherein the relative movement is a rotational movement.

25. The working apparatus as claimed in claim 22, wherein the coupling bolt of the coupling element is moved toward the inlet of the guide groove during the rotational movement in the guide groove.

26. The working apparatus as claimed in claim 22, wherein there is provided a spring element which acts in the direction of the relative movement and assists the relative movement.

27. The working apparatus as claimed in claim 1, wherein the drive motor is an internal combustion engine.
